(19) United States
(12) Patent Application Publication
(10) Pub. No.: US 2008/0285471 A1
(43) Pub. Date: Nov. 20, 2008

(54) Call Release in Communication Networks

(76) Inventor: Jurgen Tegeler, Penzberg (DE)

Correspondence Address: BELL, BOYD & LLOYD, LLP, P.O. BOX 1135, CHICAGO, IL, 60690, US

(21) Appl. No.: 10/568,733

(22) PCT Filed: May 4, 2004
(86) PCT No.: PCT/EP2004/050700

§ 371 Date: Aug. 5, 2008

(30) Foreign Application Priority Data
Aug. 19, 2003 (DE) 10338055.8

(51) Int. Cl. H04L 12/26; H04L 12/66; H04M 7/00

(52) U.S. Cl. 370/250; 370/401; 379/229; 370/352

(57) ABSTRACT

A controller requests a gateway to release a call. The gateway then disconnects and communicates the disconnect to at least one additional network node along the end-to-end connection on the resource control level. In the case of a high level recovery of a controller a temporally close stop of charging of disconnected connections is effected without the controller signaling it.

### CROSS REFERENCE TO RELATED APPLICATIONS

This application is the US National Stage of International Application No. PCT/EP2004/050700, filed May 4, 2004 and claims the benefit thereof. The International Application claims the benefits of European Patent application No. 10338055.8 DE filed Aug. 19, 2003, all of the applications are incorporated by reference herein in their entirety.

### FIELD OF THE INVENTION

In the past, two important types of communication network for transferring information have developed: packet-oriented (data) networks and circuit-switched (voice) networks. The convergence of these two network types has led to the development of convergent (voice-data) networks. The merger of these different network types has resulted in hybrid networks, in which the subject matter of the present invention is utilized with particularly noteworthy advantages.

### BACKGROUND OF THE INVENTION

Circuit-switched networks—also called voice networks or telephone networks—are designed for the transmission of continuously streaming (voice) information, this being referred to as a call or session by experts. In this type of activity, the information transfer is usually characterized by a high quality of service and reliability. For example, a minimal delay—e.g. <200 ms—without delay time fluctuations (delay jitter) is important for voice, since voice requires a continuous information flow when it is reproduced in the receiving device. Consequently an information loss cannot be compensated by retransmission of the information which was not transferred and usually results in acoustically noticeable noise interference (e.g. crackling, distortion, echo, silence) in the receiving device. Experts also refer to the transmission of voice in general terms as a ‘realtime service’.

Packet-oriented networks—also called data networks—are designed for the transfer of packet streams, which are also referred to as ‘data packet streams’ or ‘flow’ by experts. In this type of activity, it is not usually necessary to guarantee a high quality of service. Without a guaranteed quality of service, the transmission of the data packet streams is subject to e.g. temporally fluctuating delays, since the individual data packets of the data packet streams are usually transferred in the sequence in which they enter the network, i.e. the time delays increase in accordance with the number of packets that are to be transferred by a data network. Therefore experts also refer to the transmission of data as a transfer service without realtime conditions or as a ‘non-realtime service’.

The packets usually differ according to the type of packet-oriented network. They can be embodied as, for example, internet packets, X.25 packets or Frame Relay packets, or even as ATM cells. They are sometimes also referred to as messages, particularly if a message is transferred in a packet.

A well-known data network is the internet. Sometimes this is also called an IP network, on account of the Internet Protocol IP which is used therein, where this term should generally be understood to have a broad sense and include all networks in which the IP protocol is used. The internet is designed as an open (wide area) data network having open interfaces for connecting (mainly local and regional) data networks of different manufacturers. It provides a manufacturer-independent transport platform.

Connections are communication relationships or links between at least two subscribers for the purpose of a mostly reciprocal, i.e. bi-directional, transfer of information. The subscriber initiating the connection is normally termed the ‘A-subscriber’. A subscriber who is connected to an A-subscriber as a result of a connection is called a ‘B-subscriber’. In a connectionless network, connections represent at least the unique, on a logically abstract level, relationship between A-subscriber and B-subscriber, i.e. according to this way of looking at things, the connectionless flows in the internet, for example, represent logically abstract connections (e.g. A-subscriber=browser and B-subscriber=web server). In a connection-oriented network, connections represent unique paths through the network additionally on a physical level, the information being transmitted along said paths.

As a result of the convergence of voice and data networks, packet-oriented networks are likewise being used for implementing voice transmission services and increasingly also for implementing services that require more bandwidth such as e.g. transmission of moving-image information, i.e. the transfer of realtime services which previously usually involved circuit-switched transmission takes place in a convergent network—also called a voice-data network—in a packet-oriented manner, i.e. in packet streams. These are also called realtime packet streams. In this case the transmission of voice information via a packet-oriented IP network is also referred to as ‘VoIP’ (Voice over IP).

Several distributed architectures for voice-data networks are described in the international standardization bodies IETF (International Engineering Task Force) and ITU (International Telecommunications Union). A feature common to all of them is that the call control layer and the resource control layer are clearly separated from each other in functional terms and in most cases are even implemented on different platforms.

In this case the call control layer comprises at least one (optional) call controller, to which the following functions, inter alia, are assigned:
Address Translation: conversion of E.164 telephone numbers and other alias addresses (e.g. computer names) into transport addresses (e.g. internet addresses).
Admission Control (optional): basic validity check for determining whether and to what extent (e.g. VoIP-ready) devices are allowed to utilize the communication network.
Bandwidth Control (optional): management of transmission capacities.
Zone Management: registration of (e.g. VoIP-ready) devices and provision of the above functions for all devices registered with the call controller.

In addition, the following functions can optionally be assigned to a call controller on a case-by-case basis:
Call Control Signaling: all signaling messages are switched by at least one call controller, i.e. all entities send and receive signaling messages only via the call controller. Any direct exchange of signaling messages between the entities is prohibited.
Call Authorization: validity check for incoming and outgoing calls.
Bandwidth Management: controlling the permitted number of entities which are allowed to utilize the communication network concurrently.
Call Management: managing a list of current sessions, e.g. so that it is possible to generate a busy signal if this cannot be generated by the entity itself.
Alias Address Modification: returning a modified alias address, e.g. with an H.225.0 message ACF (Admission Confirmation). The endpoint must use this address during connection setup.
Dialed Digit Translation: translating the dialed digits into an E.164 telephone number or into a number from a private numbering scheme.

The ‘Gatekeeper’ proposed by the ITU in the H.323 family of standards or the ‘SIP Proxy’ proposed by the IETF are examples of call controllers. If a larger communication network is subdivided into a plurality of domains, also called ‘zones’, a separate call controller can be provided in each domain. It is also possible to operate a domain without a call controller. If a plurality of call controllers are provided in a domain, only one of these call controllers should be activated. From a logical viewpoint, a call controller should be considered as separate from the devices. In physical terms, however, it does not have to be implemented in a separate call controller entity, but can also be provided in any endpoint of a connection (e.g. embodied as an H.323 or SIP endpoint, terminal, media gateway, multipoint control unit) or even in an entity which is primarily designed for program-controlled data processing (e.g. computer, PC, server). A physically distributed implementation is also possible.

An alternative example [lacuna] a media gateway controller, to which the optional functions Call Control Signaling and Call Management are usually assigned. Moreover, the assignment of a Signaling Conversion function for converting different (signaling) protocols is also possible, which may be necessary, for example, at the boundary between two different networks which are combined to form a hybrid network.

The resource control layer comprises at least one resource controller, to which the following functions, inter alia, are assigned:
Capacity Control: controlling the traffic volume which is supplied via packet streams to the communication network, e.g. by monitoring the transmission capacity of individual packet streams.
Policy Activation (optional): reserving resources in the communication network for transmission of a prioritized packet stream if necessary.
Priority Management (optional): according to the priority of their packet streams, setting and monitoring priority flags in the packets and, if the packets are already flagged with priorities, possibly correcting priority flags in the packets.

The resource controller is also called a ‘Policy Decision Point’ (PDP). It is implemented, for example, within what are referred to as edge routers, also called edge devices, access nodes or even provider edge routers (PER) when assigned to an internet service provider (ISP). These edge routers can also be embodied as media gateways to other networks, to which the voice-data networks are connected. These media gateways are then connected to both a voice-data network and the other networks and are used internally for converting between the different (transmission) protocols of the various networks. The resource controller can also be embodied solely as a proxy and forward information that is relevant to the resource controller to a separate entity on which the relevant information is processed in accordance with a function of the resource controller.

The fundamental interaction between the two layers will be explained using the example of a call setup between two VoIP devices which are embodied as subscriber terminals. A homogeneous voice-data network is initially taken as a starting point in this case.

As part of the call setup, or sometimes even prior to the actual call setup, the authentication, authorization and (start of) accounting steps are executed when a terminal dials into the IP network (e.g. via an internet service provider). This so-called ‘AAA’ functionality is usually implemented by accessing a subscriber database in which all users are stored together with their identification codes, passwords, permissions, etc. This access is slow and comparatively complex. In the “best effort” IP networks of today, this AAA procedure normally takes place once while the user dials in. A further authentication takes place when a call controller is used, if the terminal registers with the call controller of the internet service provider. According to the ITU standard H.323, this authentication or registration of a terminal with the assigned gatekeeper is carried out in accordance with the RAS (Registration, Admission, Status) protocol which is described in the ITU standard H.225.0.

The actual call setup usually starts with a first step in which the terminals of the subscribers exchange their capabilities (e.g. list of supported CODECs) in order to determine the necessary resources (e.g. bandwidth) and the QoS (e.g. delay, jitter) that is required. In the case of voice telephony the terminals are embodied as, for example, IP telephones or VoIP client software, and in the case of online video one of the terminals could be a content or application server, for example in the network of the internet service provider (ISP).

The exchange of the signaling messages takes place either directly between the terminals or via call controller switching. In this context, the variant that is utilized in the case of each call is individually specified for each terminal and for each transmission direction. The first variant is also referred to in the H.323 terminology as ‘Direct Endpoint Call Signaling’ and the second as ‘Gatekeeper Routed Call Signaling’. In the case of direct endpoint call signaling, copies of selected signaling messages can be transmitted to a call controller if necessary, such that with this variant also a call controller is often aware of the resource and QoS requirements that are agreed between the terminals. However, these requirements are not actively influenced or verified by said call controller.

In a second, optional step, the resource and QoS requirement which is agreed in this way can be transmitted directly from the terminals of the subscribers to their assigned resource controller. After checking the resource and QoS requirement, a confirmation (or rejection) is sent back to the terminal by the resource controller.

In a third step which is likewise optional, a policy is activated in the edge router and if applicable in other routers in the network, by means of which policy these routers check and ensure that the traffic caused by the terminal is within the limits that were specified in the requirement. An example of such a reservation mechanism is RSVP (resource ReSerVation Protocol).

In order to carry out the three steps a plurality of messages are sent, said messages being used solely for reciprocal agreement among the participating components, but not for transmitting the “actual information” between the terminals. This information which is transferred with the messages is usually called signaling information, signaling data, or simply signaling. In this case the term is to be understood in a broad sense. Thus, for example, the messages conforming to the RAS protocol, the messages conforming to the ITU standard H.245 for controlling speech/data channels of existing calls, and all further similarly embodied messages are included in addition to the signaling messages. The signaling protocol for the connection setup (call setup) and connection release (call release) according to the ITU is described in the standard H.225.0, for example, and the signaling protocol according to the IETF is described in RFC 2453bis (“SIP: Session Initiation Protocol”). In order to differentiate from the signaling, the “actual information” is also called useful information, payload, media information, media data or simply media. Communication links which are used for transmitting the signaling are hereinafter also called signaling connections. The communication links which are used for transmitting the useful information are referred to as e.g. voice connection, user information channel connection or—more simply—traffic channel, bearer channel or simply bearer.

In this context out-of-band or outband is understood to mean the transmission of information on a different path/medium than that provided in the communication network for transferring signaling information and useful information. In particular it includes a local configuration of devices on site, performed for example by means of a local control device. With inband, by contrast, information is transmitted on the same path/medium, if necessary logically separated from the signaling information and useful information under consideration.

To sum up, the function split between the two layers can be described such that the resource control layer is assigned only the functions that are required for transmitting useful information, while the call control layer includes the intelligence for controlling the resource control layer. In other words: The devices of the resource control layer possess as far as possible no network control intelligence and consequently can be implemented economically particularly advantageously on separate hardware platforms. This is a particularly attractive advantage on account of the higher installation numbers in this layer compared to the call control layer.

Both in convergent voice-data networks and in hybrid networks, formed, for example, by combining a convergent voice-data network with a conventional circuit-switched voice network, new technical problems arise in the transmission of information—in particular information in realtime packet streams—due to the new or, as the case may be, different technologies that are used in the respective network types.

The object of the invention is to recognize at least one of these problems and to enrich the prior art by specifying at least one solution.

### SUMMARY OF THE INVENTION

The invention poses the question of what response is to be made to an error in the call control layer in a network in which the call control and resource control layers are clearly (mostly physically) separated from each other and are only interconnected loosely, for example by means of a control protocol (e.g. H.248 or MGCP=Media Gateway Control Protocol), if the error has repercussions on the resource control layer. In a network in which there is no clear decoupling of these two layers, an error of said kind usually leads automatically to a consequent response on the resource control layer (e.g. to the failure of a transmission link) as a result of the integrated hardware platform. In the case of (physical) distribution of the two layers, however, this consequent response no longer occurs automatically. Thus, in particular when the hardware platform of a media gateway controller fails, information can continue to be transmitted by the media gateways assigned to it, because their insulated hardware platform remains fully operational. A change only occurs when a sufficient consequent response is triggered in the media gateway by a corresponding control command, e.g. in that the transmission of (useful) information is terminated by releasing the (bearer) connection by means of a MGCP:DLCX or H.248:ServiceChange message.

Thus, for the present, distributed architecture the essential question being posed is whether—and if the answer is affirmative—to what degree an error in the call control layer is to adversely affect the resource control layer. If the coupling of the two layers is too slight, there are problems with data consistency (e.g. a false image of the states in the resource control layer is present in the call control layer; charging continues in spite of bearer failure). If the coupling is too strong (e.g. a failure of an entity of the call control layer also leads to an equivalent failure of the associated entities of the resource control layer), then there are unnecessarily long downtimes and unnecessary risks during the restart of the network.

Within the scope of the function split, as described in the introduction, of the bipartite architecture, the effect of a control command is in this case limited purely locally to the entity addressed in each case (e.g. media gateway). As a consequence of this modular philosophy, a corresponding control command is required to each entity of the resource control layer controlled in this way along a connection in order to achieve a full release of the connection.

This can, however, lead to problems with the charging of the call, because the (bearer) connection can no longer be used for an end-to-end transmission of information between subscribers already after the first control command if the media gateway affected by said command no longer recognizes the call cleared in said way and no longer discharges the gateway function. Consequently the charging must be terminated as far as possible simultaneously with the first successful control command and must not end only when the call is cleared in the node in which the charging of the call is also performed.

It is known in circuit-switched TDM (Time Division Multiplex) networks to physically deactivate all PCM (Pulse Code Modulation) links following the failure of a TDM switching node. This is detected by the hardware maintenance of the adjacent TDM switching node after a delay lasting a few seconds and reported to its internal controller. Said controller thereupon determines the connections affected by the failure and signals the failure of the connections to all the affected switching nodes of the TDM network by means of SS7 messages. On account of said messages the charging of the calls is terminated close in time to the initial failure of the first switching node.

However, this method ceases to work in a hybrid network consisting of a packet-oriented network and a circuit-switched TDM network, because in a media gateway the PCM links in which the bearers are routed in the TDM network continue to remain physically active even after a call has been released. Consequently, the adjacent (in the sense of: along the connection released in the media gateway) TDM switching nodes which terminate the affected PCM links cannot recognize on the basis of the PCM links—i.e. on the resource control layer—that the end-to-end bearer has failed over these links.

According to the function split of the bipartite architecture this behavior is the expected solution, because in the correct manner the signaling is intended to be performed on the call control layer and not on the resource control layer. Accordingly, the failure of the bearer is categorically notified to the adjacent TDM nodes via the call signaling (SS7)—i.e. on the call control layer—because the intelligence for controlling the network is assigned to this layer.

However, in the case of an accumulation of errors—e.g. as a result of a high-level recovery of a media gateway controller—the architecture-compliant standard solution leads to a plurality of problems because it cannot be guaranteed that the signaling of the bearer failure to adjacent TDM nodes takes place in synchronism with the actual failure:

When a media gateway controller executes a high-level recovery, all still existing user information channel connections in the media gateways controlled by the controller must be cleared so that a consistent image of the states of the assigned gateways is present once again after completion of the recovery in the controller. As long as this image is not present, no new connections can be created in the gateways by the controller. The release must therefore be executed as quickly as possible in order to minimize the length of time in which no new connections can be created. For this reason the protocol for controlling the gateways is reactivated as early as possible during the recovery of the controller in order to enable the still existing transient call data in the gateways to be deleted. When a connection is deleted, the end-to-end connection still existing up to that point is interrupted. Consequently, the charging should also be terminated as of this time. To that end, corresponding signaling messages—as described above—would have to be sent on the call control layer. This is not possible, however, because the protocols required for this (e.g. BICC, SIP_T, SS7) are still not activated at this time. It is therefore necessary to wait until they have been activated, which can lead to an offset of several minutes between the interruption of the end-to-end connection and the termination of the charging.

With a large controller there is also a scaling problem, because the release of a plurality of connections leads to a flood of signaling messages. Depending on the implementation of the controller, its size and the general traffic load in the signaling network, the offset between the failure of the bearer and the termination of the charging is enlarged to an incalculable degree and can amount to 30 min or more. This accumulation of unjustified charges is unacceptable.

A solution to this problem situation on which the invention is based is set forth in the claims.

A great number of advantages are associated with this solution:
The solution is compliant with the MGCP/H.248 standards, because the standardized minimum behavior in response to a control command from the call control layer is simply extended, not changed.
On account of this compliance, only minimal modifications to existing devices are necessary in order to implement the invention, as a result of which it can be realized very advantageously in economic terms.
Owing to the notification to at least one network node along the connection, the logical coupling between the two layers, which are implemented on a distributed basis, is strengthened, as a result of which the inconsistencies described (bearer no longer available—charge metering continues) can be more easily avoided.
Owing to the notification on the resource control layer, the scaling problem is significantly mitigated because the signaling messages to these network nodes can be dispensed with.
The problem of the time offset in the case of a high-level recovery of a controller is alleviated since the notification on the resource control layer can be effected in immediate proximity in time to the release of the connection, without any need to wait for an activation of corresponding protocols of the call control layer. Moreover, the notifications can be generated in parallel by the processors on the modules if different modules are affected by the control messages. This is more effective than the generally forcibly sequentialized sending of signaling messages by a centralized controller.
In the event of a high-level recovery of a media gateway controller from which an interconnection with a TDM network is effected, a notification to an adjacent TDM switching node (e.g. due to failure or reentry into service of PCM links) leads on the TDM side to ISUP synchronization messages (GRS/RSC) from the TDM switching node to the controller undergoing the recovery, which messages, if not answered, are repeated cyclically. The controller undergoing the recovery begins, from a certain point in its recovery, to send GRS/RSC messages itself and to acknowledge those received. Because adjacent TDM switching nodes also assist in taking on the work of ISUP synchronization following recovery of the controller, on the one hand the controller undergoing recovery is dynamically relieved of its load, and on the other the synchronization is completed more rapidly, the full call processing availability of the controller thereby being restored at an earlier point in time.

Other advantageous embodiments of the invention will emerge from the dependent or independent claims.

In the event of notification due to failure (e.g. deactivation) of a transmission channel to a switching node of a circuit-switched network, the failure—provided it lasts long enough (e.g. several seconds)—is detected by the hardware monitoring of the node. This node thereupon initiates the release of the TDM bearer on both sides in the circuit-switched network. If the charging is handled in this network (e.g. if the node is disposed in an ingress-side circuit-switched network to which the subscriber to be charged is also assigned), this charging is also stopped. The failure of the transmission channel advantageously affects no connections that were not to be released if (as is the case, for example, for a high-level recovery of the controller) all the connections in the assigned gateways are released. As a result of the tried-and-tested release mechanisms existing in the circuit-switched network, this termination of the charging takes place close in time to the interruption of the end-to-end bearer in the media gateway. In the event of a high-level recovery of a media gateway controller, in this way the charge metering is stopped close in time to the failure of the bearer and is not delayed by the recovery.

In a packet-oriented network the failure of a transmission channel is simulated through notification with the aid of special messages—in particular through inband sending of RTCP packets by means of which the information “Packet Loss=100%” is displayed—so that the actual transmission channel advantageously continues to remain active and can be used for other information transmissions.

For the situation where the gateway to which the release of a connection is notified with the aid of special messages is interconnected with a circuit-switched network, the release notification is relayed to the circuit-switched network so that the charging in this network can be stopped as close as possible in time.

Provided this relayed notification is communicated, not by failure of the transmission channel, but by means of a message to the assigned controller and then on the call control layer, there are advantageously no interruptions to other connections that are also carried in the transmission channels to the circuit-switched network. In this way, in addition, a return is made as quickly as possible to the architecture-compliant signaling on the call control layer. Furthermore this return is performed in a distributed manner to a plurality of controllers which for their part are not undergoing a recovery, so a very efficient distribution of the signaling load is effected, which load, with architecture-compliant signaling, would otherwise have to be borne on its own by the controller, which, apart from the absence of load distribution, in any case also has insufficient resources available during its recovery to be able to process this signaling.

### BRIEF DESCRIPTION OF THE DRAWINGS

The invention will be explained below with reference to further exemplary embodiments which are also illustrated in the figures, in which:

FIG. 1 shows an arrangement for performing the method according to the invention with a hybrid communication network, consisting of a packet-oriented integrated voice-data network and two circuit-switched voice networks which are connected by means of intermediate media gateways and media gateway controllers, as well as two endpoints of an information transmission

FIG. 2 shows the arrangement according to FIG. 1 in which the ingress-side embodiments of the method according to the invention are illustrated

FIG. 3 shows the arrangement according to FIG. 1 in which the egress-side embodiments of the method according to the invention are illustrated in an exemplary manner

### DETAILED DESCRIPTION OF THE INVENTION

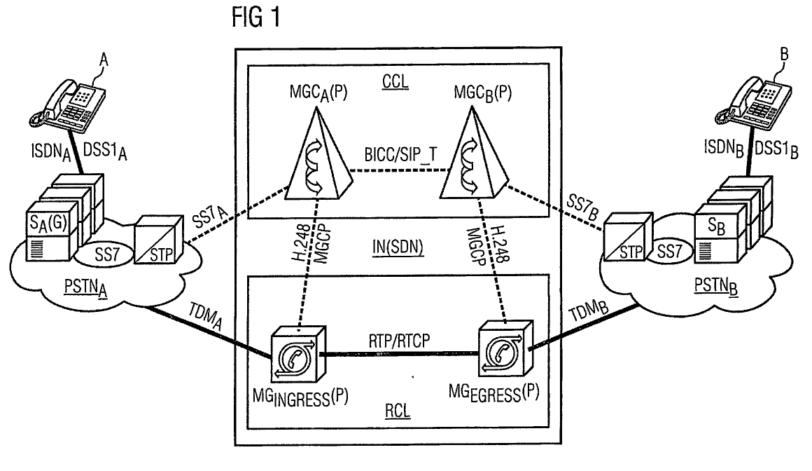

FIG. 1 shows an exemplary arrangement for performing the method according to the invention. It comprises two circuit-switched networks PSTN_{A}, PSTN_{B} and a communication network IN which is preferably embodied as an integrated voice-data network SDN. The three networks are interconnected to form a hybrid network in which the network IN in particular is used for virtual trunking of voice connections between the PSTN networks. The network IN is preferably embodied as an IP network (e.g. the internet). For the appropriate person skilled in the art it is obvious here that the invention can of course be used in other network scenarios, in particular further packet-oriented networks, such as, for example, an intranet, extranet, a local area network (LAN) or a corporate network embodied, for example, as a virtual private network (VPN).

The network IN includes a call control layer CCL, to which the controllers MGC are assigned, and a resource control layer RCL, to which the media gateways MG are assigned. The gateways MG are in each case controlled by a controller MGC assigned thereto using a—preferably internationally standardized—protocol, e.g. MGCP (Media Gateway Control Protocol) or H.248, and are typically implemented as separate units which run on different physical devices/hardware platforms than the controllers MGC.

The circuit-switched bearers TDM_{A}, TDM_{B} are interconnected by means of intermediate media gateways MG for converting between different, network-specific user information channel technologies RTP/RTCP (Real Time [Control] Protocol) and TDM (Time Division Multiplex), and the circuit-switched signaling channels SS7_{A}, SS7_{B} are interconnected by means of intermediate media gateway controllers MGC for converting between different network-specific signaling protocols SIP (Session Initiation Protocol), BICC (Bearer Independent Call Control), SIP_T (SIP for Telephones) and SS7 (Signaling System No. 7).

An A-subscriber A is connected to the network PSTN_{A}, a B-subscriber B to the network PSTN_{B}, between which subscribers an end-to-end user information connection ISDN_{A}, TDM_{A}, RTP/RTCP, TDM_{B}, ISDN_{B} is set up as bearer. The charging G of the call is performed in the customary way on the calling A-subscriber side in the switching node S_{A} of the network PSTN_{A}.

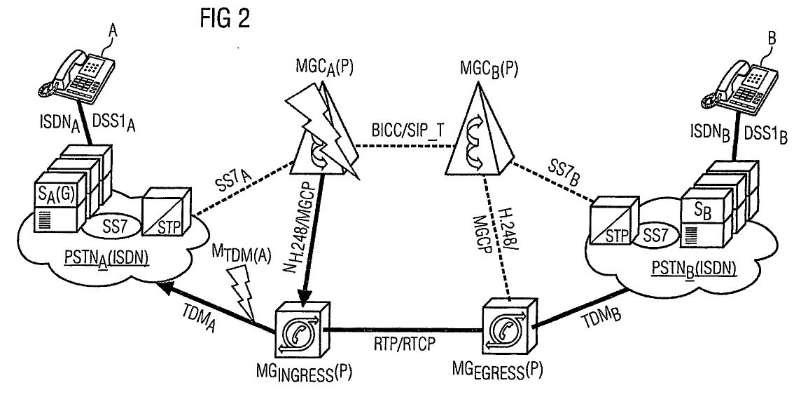

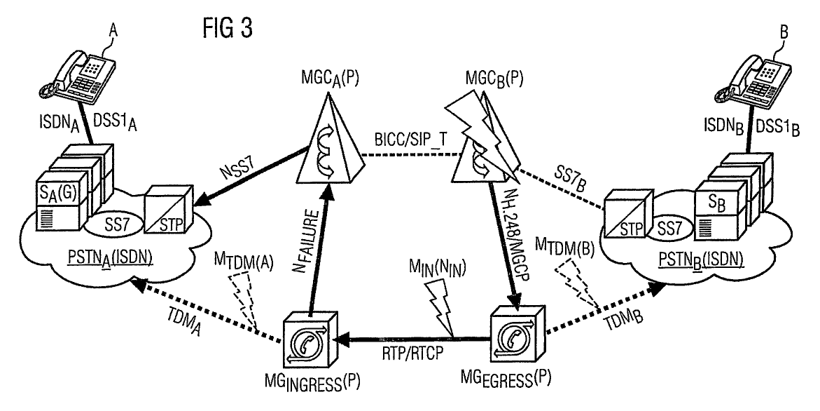

For the purpose of a simplified illustration of the invention, FIGS. 2 and 3 are in each case geared to merely a uni-directional consideration of an end-to-end connection which extends from the calling subscriber A to the called subscriber B. With regard to this transmission direction, the gateway MG between the network PSTN_{A} and the network IN is designated as gateway MG_{INGRESS} and the gateway MG between the network IN and the network PSTN_{B} as gateway MG_{EGRESS}, where the entry of the user information connection into the network IN is indicated by the index ‘INGRESS’ and the exit of the user information connection from the network IN is indicated by the index ‘EGRESS’.

In this scenario, FIG. 2 shows a message N_{H.248/MGCP} from the controller MGC_{A} to the gateway MG_{INGRESS} and a notification M_{TDM} from the gateway MG_{INGRESS} to the network PSTN_{A} which messages and notifications are transmitted in particular during recovery of the inventive controller MGC_{A} assigned to the gateway MG_{INGRESS}.

FIG. 3 shows messages N_{H.248/MGCP} from the controller MGC_{B} to the gateway MG_{EGRESS}, N_{IN} (as an embodiment of a notification M_{IN}) from the gateway MG_{EGRESS} to the gateway MG_{INGRESS}, N_{FAILURE} from the gateway MG_{INGRESS} to the controller MGC_{A}, N_{SS7} from the controller MGC_{A} to the network PSTN_{A}, as well as optional notifications M_{TDM (A)} and M_{TDM (B)} from the two gateways MG to the networks PSTN_{A} and PSTN_{B} indicated by means of an index in each case, which notifications are transmitted in particular during recovery of the inventive controller MGC_{B} assigned to the gateway MG_{EGRESS}.

It should be emphasized that the embodiments of the invention illustrated in such a manner are, in spite of their sometimes very detailed and faithful representation of actual network scenarios, simply of an exemplary nature and are not to be understood as restrictive. It is clear to the person skilled in the art that the invention works not only in virtual trunking scenarios, but in all conceivable network configurations, in particular other interworking scenarios.

As further exemplary embodiments of the invention, the high-level recovery of an ingress-side controller MGC_{A} and an egress-side controller MGC_{B} are explained by way of example with reference to the network configuration according to FIG. 1.

For the exemplary embodiment of the high-level recovery of an ingress-side controller MGC_{A}, messages N and notifications M of the invention are shown in FIG. 2. In the course of a high-level recovery of the controller MGC_{A}, all still existing connections are usually released in the assigned gateway MG_{INGRESS}. These connections are essentially still known to the controller MGC_{A} even after a recovery, because they are stored (semi-) permanently for example in a database of the controller, even if they have an undefined status, because, for example, an unknown number of messages were not received by the gateway MG_{INGRESS} prior to or during the recovery.

The controller MGC_{A} sends to the gateway MG_{INGRESS} control messages N_{H.248/MGCP} by means of which the gateway MG_{INGRESS} is instructed to release all still existing connections. The messages N_{H.248/MGCP} which lead to the deletion of the transient call data on the gateway MG are embodied, for example, as message MGCP:DLCX of the IETF standard MGCP or as message H.248:ServiceChange of the ITU-T standard H.248. These messages are extended in this example such that they indicate the cause of the error (i.e. in the present case, the recovery of the controller MGC_{A}) to the receiving gateway MG_{INGRESS}.

When the delete command DLCX of the MGCP protocol is used, a wildcard mechanism, for example, can be used by means of which, in the case of a hierarchical name structure of the (local) endpoints of the connections, a group of endpoints can be addressed using the wildcard “*” (asterisk) (cf. also RFC 2705:MGCP, section 2.3.7). Preferably the group includes at least all the calls that are transmitted to the network PSTN_{A} over a particular link, because in this way no existing connections are deactivated by the notification M_{TDM}. The command DLCX is supplemented by an additional parameter “reason code”, which unambiguously indicates that the recovery scenario described here is present in the controller MGC.

When use is made of the ServiceChange command of the H.248 protocol, the parameter values TerminationID=Root, ServiceChangeMethod=Forced can be used, for example. According to the H.248 standard, the ServiceChange command with the parameter value ServiceChangeMethod=Forced is provided merely as a message from the gateway MG to the controller MGC. The use of this command in the opposite direction, i.e. from the controller MGC to the gateway MG, represents an extension of the standard. Provided it is reserved specifically for the recovery scenarios, the indicator of the error cause is contained in the reservation as such, so a separate parameter for indicating the cause of the error can advantageously be dispensed with.

After receiving the control messages N_{H.248/MGCP}, the gateway MG_{INGRESSS} releases the indicated connection(s) in its (their) context in accordance with the standard-compliant responses. In addition, as a response to the indicated error cause, it allows the associated PCM links to fail physically and activates them again after a certain time period which is dimensioned such that the hardware maintenance function of conventional TDM switching nodes S on the opposite side notice and flag the failure. As a consequence, the bearers ISDN_{A}, TDM_{A} are then released in the usual way in the network PSTN_{A} and the charging G is stopped close in time to the interruption of the end-to-end connection.

For the exemplary embodiment of the high-level recovery of an egress-side controller MGC_{B}, messages N and notifications M of the invention are shown in FIG. 3. In this case all still existing calls are released in the assigned gateway MG_{EGRESS}, whereby it is assumed that this is indicated to the gateway MG_{EGRESS} by the controller MGC_{B} by means of control messages N_{H.248/MGCP} analogously to the ingress-side exemplary embodiment.

After receiving the control messages N_{H.248/MGCP}, the gateway MG_{EGRESSS} releases the indicated connection(s) in its (their) context in accordance with the standard-compliant responses. In addition, as a response to the indicated error cause, the gateway MG_{INGRESS} is notified of the release of the connection(s) on the resource control layer RCL. This notification M_{IN} is effected, for example, by means of special messages N_{IN} for all the bearer streams RTP associated with the released connections, which messages are embodied e.g. as packets RTCP with a parameter value Packet Loss=100%. This takes place as close in time as possible to the releasing of the connections. Advantageously the sending of the messages N_{IN} is smoothed in order to avoid floods of messages.

For its part, the gateway MG_{INGRESS} notifies the failure of the connection to the upstream PSTN_{A} after a threshold value of received messages N_{IN} has been exceeded. According to a variant of the invention, this notification M_{TDM (A)} is effected on the resource control layer RCL by, for example, a brief deactivation of the associated PCM links to the network PSTN_{A}. According to an alternative variant of the invention, the notification is effected on the call control layer CCL. For this purpose, the controller MGC_{A} is notified by the gateway MG_{INGRESS} by means of messages N_{FAILURE} of the failure of the connections detected on the basis of the messages N_{IN}, whereupon said failure is notified to the network PSTN_{A} by the controller MGC_{A} in the usual way by means of signaling messages N_{SS7}. After this notification is received, the bearers ISDN_{A}, TDM_{A} are then released in the network PSTN_{A} in the usual way and the charging G is stopped close in time to the interruption of the end-to-end connection.

Optionally, the gateway MG_{EGRESS} also notifies the release of the connections in the forward direction on the resource control layer RCL. In the case of interconnection with network PSTN_{B} arranged downstream, this notification M_{TDM (B)} can in turn be effected by physical deactivation of the transmission links. In this way the bearers TDM_{B}, ISDN_{B} are advantageously released for new reservations close in time to the failure of the connections in the network PSTN_{B}. This advantage is particularly attractive if the usual release on the call control layer CCL cannot be effected, or can be effected only with a delay, as a consequence of the recovery of the controller MGC_{B}.

It is clear to the person skilled in the art that the invention works not only in the virtual trunking scenarios in which the controller MGC_{A} of the ingress-side MG_{INGRESS} or, as the case may be, the controller MGC_{B} of the egress-side gateway MG_{EGRESS} undergoes a high-level recovery, but in all conceivable network configurations, in particular all interworking scenarios such as TDM < > IP phone or TDM <-> Access Gateway, in particular if the failure of the IP bearer RTP is converted into the failure of the associated (via the virtual trunking gateway MG) PCM links. Thus, the failure of the user information channels is signaled immediately into the network in all cases, i.e. without any delay due to the recovery of the controller MGC.

It is also clear to the person skilled in the art that the two scenarios described can, of course, be superimposed on one another without difficulty in a bi-directional connection, i.e. that, for example, in the case of a gateway MG_{INGRESS}, not only a notification M_{TDM} can be initiated in the direction of the PSTN_{A}, but in parallel therewith in the opposite direction—i.e. the transmission direction from subscriber B to subscriber A (in respect of which the gateway MG_{INGRESS} then represents an EGRESS)—a notification M_{IN} in the direction of the gateway MG_{EGRESS} can also be triggered in addition.

Finally it should be pointed out that the description of the components of the communication network that are relevant to the invention is absolutely not to be understood as restrictive. For an appropriate person skilled in the art it is in particular obvious that terms such as application, client, server, gateway, controller, etc. . . . are to be understood in a functional sense and not physically. Thus, for example, the endpoints A, B can also be implemented in part or in full in software/computer program products P and/or in a distributed manner over a plurality of physical devices.

1-10. (canceled)

11. A method for releasing a connection in a communication network, comprising:
assigning a controller to a call control layer;
assigning a gateway to a resource control layer controlled by the controller;
implementing the gateway as a separate unit from the controller;
sending a control message from the controller to the gateway to release the connection;
releasing the connection in the gateway;
notifying the release to at least one network node along the connection; and
effecting the notification on the resource control layer.

12. The method as claimed in claim 11, wherein the communication network is a packet-oriented network.

13. The method as claimed in claim 12, wherein the packet-oriented network is an integrated voice-data network.

14. The method as claimed in claim 11, wherein the communication network is interconnected with a circuit-switched network via the gateway.

15. The method as claimed in claim 11, wherein the call control layer and the resource control layer are functionally split such that the resource control layer is assigned only functions that are required for transmitting information and possesses no network control function, and the call control layer includes the network control function for controlling the resource control layer.

16. The method as claimed in claim 11, wherein the gateway which is controlled by the controller is implemented on a different physical device from the controller.

17. The method as claimed in claim 11, wherein the gateway which is controlled by the controller is implemented on a different hardware platform from the controllers.

18. The method as claimed in claim 11, wherein the control message is sent if a recovery of the controller occurs.

19. A method for releasing a connection in a communication network that is interconnected with a calling subscriber circuit-switched network via a gateway, comprising:
assigning a controller to a call control layer;
assigning the gateway to a resource control layer controlled by the controller;
sending a control message from the controller to the gateway to release the connection;
releasing the connection in the gateway;
notifying the release to a switching node of the calling subscriber circuit-switched network; and
effecting the notification on the resource control layer if a failure of a transmission channel between the gateway and the switching node occurs.

20. The method as claimed in claim 19, wherein the failure causes a hardware monitoring of the switching node to report the transmission channel as failed.

21. The method as claimed in claim 19, wherein the control message is sent if a recovery of the controller that controls the gateway that is interconnected with the calling subscriber circuit-switched network occurs.

22. A method for releasing a connection in a communication network that is interconnected with a called subscriber circuit-switched network via a gateway, comprising:
assigning a controller to a call control layer;
assigning the gateway to a resource control layer controlled by the controller;
sending a control message from the controller to the gateway to release the connection;
releasing the connection in the gateway; and
notifying the release to a second gateway node of the communication network by sending a special message from a first gateway to the second gateway.

23. The method as claimed in claim 22, wherein the first gateway is interconnected with a called subscriber circuit-switched network.

24. The method as claimed in claim 22, wherein the second gateway is interconnected with a calling subscriber circuit-switched network.

25. The method as claimed in claim 22, wherein the special message is RTCP packet by means of which an information “Packet Loss=100%” is displayed from the first gateway to the second gateway.

26. The method as claimed in claim 22, wherein the second gateway, after exceeding a threshold value of the special message, notifies the release of the connection on the resource control layer to at least one further network node.

27. The method as claimed in claim 26, wherein the further network node is a switching node of a circuit-switched network.

28. The method as claimed in claim 22, wherein the notification is transmitted by the second gateway to the controller on the call control layer to a further network node.

29. The method as claimed in claim 28, wherein the further network node is a switching node of a circuit-switched network.

30. The method as claimed in claim 22, wherein the control message is sent if a recovery of the controller that controls the first gateway occurs.
